(19) United States
(12) Patent Application Publication
(10) Pub. No.: US 2006/0151108 A1
(43) Pub. Date: Jul. 13, 2006

(54) Method and apparatus for forming layered thermoformable materials

(75) Inventors: Thomas St. Denis, Rowayton, CT (US); Gabriel M. Karamanis, Stamford, CT (US); Mark Austin, New Rochelle, NY (US)

Correspondence Address: Paul D. Greeley, Esq.;Ohlandt, Greeley, Ruggiero & Perle, L.L.P., One Landmark Square, 10th Floor, Stamford, CT, 06901-2682, US

(73) Assignee: PANTERRA ENGINEERED PLASTICS, INC

(21) Appl. No.: 11/292,448

(22) Filed: Dec. 2, 2005

Related U.S. Application Data
(60) Provisional application No. 60/632,421, filed on Dec. 2, 2004.

(51) Int. Cl. B32B 37/00; B32B 37/06; B32B 37/20

(52) U.S. Cl. 156/309.9; 156/73.1; 156/272.2; 156/272.8; 156/322; 156/324; 156/308.2; 156/359; 156/543; 156/555; 156/64

(57) ABSTRACT

A method for continuously producing high-strength welded composite panels from thermoformable material facings and expanded thermoformable material cores comprising the steps of: simultaneously feeding facing sheets and core into a welder that has automated feed rollers; heating the lower side of the top face and the upper side of the lower face simultaneously with both faces of the inner core of expanded thermoformable material; continuing to heat them to 100-400° C. until the surfaces reach the initial melt and/or hot tack temperature of the materials; pressing the heated faces together against the heated surface of the core material to consolidate the composite structure; and allowing the materials to cool while under pressure and continuing to move forward in the engaged roller mechanism until the entire panel has been welded and is dimensionally stable.

### CROSS REFERENCE TO RELATED APPLICATION

The present application is claiming priority of U.S. Provisional Application Ser. No. 60/632,421, filed on Dec. 2, 2004.

### BACKGROUND OF THE INVENTION

1. Field of the Invention

The present invention relates to a method and apparatus for forming layered thermoformable materials. More specifically, the present invention relates to a method and apparatus for producing composite panels made from expanded thermoformable materials by weld bonding faces of thermoformable materials thereto, thereby yielding a cost-effective, lightweight, high-strength integral composite panel.

2. Description of the Prior Art

Processes used to make expanded thermoformable materials are described in the prior art and typically involve placing a thermoformable polymeric material blank between mold plates, which are attached to a heated press. A thermoformable polymeric material blank is typically heated to a temperature at which the surfaces of the thermoformable polymeric material will adhesively bond with their respective adjacent mold plates by hot tack adhesion. The mold plates are then separated apart with the thermoformable material still adhered to the mold plates so as to affect an expansion of the cross-section of the thermoformable material.

Typically, the surfaces of the mold plates that are bonded to the thermoplastic material blank have a plurality of perforations thereon. The thermoplastic material will adhesively bond to the non-perforated portion of this surface so that when the mold plates are separated apart a plurality of cells will be formed within the cross-section of the expanded thermoformable material. Generally, these perforations can have a variety of different geometries and can be arranged in an array of patterns on the surface of the mold plates, thereby creating thermoformable materials having a variety of cross-sectional geometries. Such methods for expanding thermoformable materials are set forth in U.S. Pat. No. 6,322,651, issued on Nov. 27, 2001 to Phelps, U.S. Pat. No. 4,113,909, issued on Sep. 12, 1978 to Beasley, U.S. Pat. No. 4,164,389, issued on Aug. 14, 1979 to Beasley, U.S. Pat. No. 4,315,051, issued on Feb. 9, 1982 to Rourke, U.S. Pat. No. 4,269,586 issued on May 26, 1981 to Ronayne, U.S. Pat. No. 4,264,293, issued on Apr. 28, 1981 to Rourke, and U.S. Pat. No. 4,315,050 issued on Feb. 9, 1982 to Rourke, each of which is incorporated herein by reference.

In many cases these expanded thermoformable materials are then integrated into a composite panel using various approaches of laminating and bonding with adhesives that will be familiar to one versed in the art. These techniques for laminating and bonding include manual, automated and semi-automated processes, where the bonding agent may be applied by brush, roller, spray, dipping or other means. Faces or exterior surface layers are then applied to the expanded thermoformable material, and, due to the physical properties of the faces, adhesive and/or core, pressure is optionally applied, sometimes for lengthy periods of time depending upon the dwell/cure time of the adhesive bonding agent.

One disadvantage of the conventional laminating and bonding techniques is that the adhesive bonding agents are often toxic and/or aggressive chemicals requiring that they be handled with care and that the volatile vapors be scrubbed before being released into the atmosphere. While these laminating and bonding techniques are well known, they add to the cost of the finished product because of the additional materials, manpower, or energy needed, or because of added steps such as cleaning, preparing, or treating bonding surfaces.

Another significant disadvantage of the prior art is the use of costly laminating or bonding equipment that can take up a considerable amount of manufacturing space.

A further significant disadvantage of the prior art is the use of costly and hard to handle liquid, paste and film adhesives. These adhesives are generally hard to handle or mix and can range in cost from $0.50-2.00 per square foot, depending on the type of adhesive and the amount that is applied to produce a sound structural bond between the thermoformable material and the facing material. Also, with these adhesives precise mixing and application procedures must be followed. Otherwise the adhesive bonds produced will be inferior, producing a composite panel that is not structurally sound. This process adds additional manpower expenses and the potential for human error.

Yet another major disadvantage of the previous methods is the problem of cure time. Some of these bonding agents require a significant dwell or cure time to reach their full curing strength, especially if one wants to use the less toxic and less aggressive chemical bonding agents. This dwell or cure time also requires the application of consistent and uniform pressure to keep the facing material in constant contact with the expanded thermoformable material. Since these composite panels are often large, they can take up significant floor space while they are curing.

Furthermore, another major disadvantage of these conventional laminating and bonding methods is that the flexural strength of the finished composite panel is dependent upon the strength of the bond between the face and the expanded thermoformable material. In many applications, such as an office partition, the flexural strength requirements of the panel may be insignificant. However, there are many, many applications ranging from industrial, to transportation, to architectural, where the flexural strength of the panel is very important, and a significant requirement of the panel to ensure that it functions properly.

U.S. Pat. No. 4,353,857, issued on Oct. 12, 1982 to Ray et al. and entitled “Method for Making Plastic Panel and Panel,” relates to producing a compression molded fiber reinforced plastic closure panel utilizing fiber reinforced molding materials. Panels utilizing this method cannot be made continuously and must use messy, dusty and hard to handle molding materials. U.S. Pat. No. 5,736,221, issued on Apr. 7, 1998 to Hardigg et al. and entitled “Welded Plastic Panels and Method of Making Same,” relates to producing an injection molded panel composed of two half-panels or panel portions. Each panel portion comprises a skin having matching integral webs or ribs disposed perpendicular to the skin, wherein the half-panels are bonded together along the webs or ribs. The panel portions are bonded together by either hot plate or adhesive bonding or friction welding. Materials that can be friction welded are limited to polyethylene, polypropylene, polycarbonate, acrylic and acrylonitrile-butadiene-styrene polymers. Additionally, panels utilizing this method cannot be made continuously. U.S. Pat. No. 5,660,669, issued on Aug. 26, 1997 to Mittleider and entitled “Thermoplastic Welding,” relates to a method for thermoplastic welding by fusion bonding and an assembly of composite parts, each having a resin-rich thermoplastic surface layer along bond lines containing a conductive receptor between the components. This method is complex and panels cannot be made continuously.

There are numerous additional disadvantages with the approaches to thermoplastic welding described above.

Yet another disadvantage of conventional welding systems for thermoformable materials is that they are not easily amenable to welding planar surfaces, or if they are, are expensive or difficult to scale up to large panel sizes.

Accordingly, there is a need for an improved method and apparatus for producing composite panels using expanded thermoformable materials as the core with bonded facings that can overcome the disadvantages of the currently available methods and apparatus described above.

The present invention overcomes all of the aforementioned disadvantages of the adhesive bonding or thermoplastic welding processes discussed above.

The present invention also provides a cost-effective method and apparatus for producing thermoformable panels that use a minimal amount of raw materials and manpower, and that do not occupy a lot of manufacturing space.

The present invention also provides a method and apparatus for thermoformable panels that are capable of producing such panels with significantly larger surface areas over those currently available in the art.

The present invention further provides a method and apparatus for producing the thermoformable panels that require no dwell or cure time.

The present invention produces panels which exhibit significantly stronger panel flexural strength compared to bonded panels.

Finally, the present invention provides a method and apparatus for producing thermoformable panels that require significantly less manpower than the lamination and/or bonding methods discussed above.

### SUMMARY OF THE INVENTION

A method and apparatus for producing panels containing expanded thermoformable cores with weld bonded thermoformable facing materials that allows for the continuous production of the panels.

The present invention provides a cost-effective method and apparatus for continuously producing integrally weld bonded, high strength layered or composite panels with thermoformable faces and expanded thermoformable material cores. This method and apparatus comprises the steps of: simultaneously feeding one or more facing material sheets and a core material into a welder that has automated feed rollers; transferring energy to one side of at least one of the facing material sheets and to the side of the core material that will be welded to that facing material; continuing to apply energy to them until the surfaces reach the initial melting point and/or hot tack temperature of the materials; pressing one or more heated surfaces of the facing material against the heated surface of the core material; allowing the materials to cool and bond while under pressure; and moving the materials forward in the engaged roller mechanism until the entire panel has been welded and is dimensionally stable.

The facing panels are welded to the core material and not bonded by chemical adhesives. Energy is applied to the welding faces, so that when they are pressed together they form a unitary or homogenous structure, without any intermediary layers, which is a significant advantage over currently available systems and methods for forming such panels. Testing has shown that the strength of the finished product made by this process is up to 2-3 times as strong as similar materials bonded by chemical adhesives. Importantly, this process can be performed continuously, which allows for the formation of welded panels of indefinite length and is another advantage over currently available systems and methods. The process can also be performed in batch mode, which still produces the welded panels in a much shorter time than those in the prior art.

The facing panels can also be preheated with a secondary energy source so that the energy required to bring them up to weld bonding temperature is the same as the energy required to bring the surface of the expanded thermoplastic material up to weld bonding temperature.

In another embodiment of the invention, only one side of the expanded thermoformable material is weld bonded at one time, thus minimizing the total amount of thermal energy absorbed by the interior cell walls and ensuring that they remain stable and do not overheat.

In another embodiment of the invention, when facing layers and core layers have differing surface thicknesses and/or different materials, methods are included that allow different amounts of energy to be directed towards each surface. These methods include the ability to move the heating element closer to one surface than another; a second heating element so that each surface has its own, independent heating element; and a masking device for the heating element that lessens the energy radiated from one side relative to the other.

The present invention can also have a different mask that is fed into the welding apparatus between the facing material and the core material. This mask can help to prevent the interior area of the core from absorbing too much heat and overheating.

The present invention also includes a microprocessor control that varies the energy received by the surfaces of the facing panels or expanded thermoformable core materials by varying the intensity of the energy source, the distance of the energy source to the surface of the materials, the speed of the panels or the thermoformable materials as they pass by the thermal source, or any combination of the above. The microprocessor is capable of performing the following steps: receiving data input from temperature sensors for the facing panel after it passes by a heating element; comparing the actual temperature to a predetermined temperature for the composition of the facing material; and sending an output signal to the heating element to increase or reduce energy so as to bring the surface temperature of the facing panel to the predetermined temperature. Optionally, additional inputs and outputs could be used as additional heating elements are used in a multi-layered thermoforming composite.

Optionally, the microprocessor could include the following steps: receiving data input from the temperature sensor for the facing panel after the heating element; receiving data input from the temperature sensor for the core layer after the heating element; comparing both temperatures to their individual predetermined temperature settings for the composition of their respective materials; and sending an output signal to the heating element to increase or reduce the distance between the heating element and the facing and/or core, thereby to vary the amount of energy received by them. The purpose and function of this microprocessor controller is to ensure the quality of the welded bond by dynamically maintaining proper temperature conditions for the bond to take place.

One versed in the art will understand that there are a variety of sensor inputs, preset ranges, and output controls that can be effectuated to achieve this result. For example, the microprocessor can take input from sensors that detect the surface temperature, thickness, color, reflectance, or absorption of the thermoformable materials used in the present invention, or any combination of these parameters. The microprocessor can also receive input data regarding characteristics of the thermoformable materials such as the bonding temperature. The microprocessor can use these inputs to vary the energy received by the facing panels and thermoformable core material, both individually or in tandem, as described above. The output mechanism for varying the energy received can include direct adjustments to the energy of the heating device, adjustments to the proximity of the heating device to the surface, and adjustments to a masking device that shields the output of the heating element.

Other and further objects, advantages and features of the present invention will be understood by reference to the following specification in conjunction with the annexed drawings, wherein like parts have been given like numbers.

### BRIEF DESCRIPTION OF THE DRAWINGS

FIG. 1 is a schematic representation of the automated thermoplastic composite panel welder according to the present invention.

FIG. 2 is a schematic representation of the automated thermoplastic welder according to the present invention, having a mask layer that is integrally bonded to the core.

FIG. 3 is a schematic representation of the automated thermoplastic welder according to the present invention, having a mask layer that is not integrally bonded to the core.

FIG. 4 is a side view of the core layer and mask layer of the present invention as they pass under the heating source.

FIG. 5 is a top view of a core material produced by the present invention.

FIG. 6 is a top view of a mask layer used in the present invention.

FIG. 7 is a top view of the mask layer of FIG. 6 superimposed on the core material of FIG. 5.

FIG. 8 is a schematic representation of the automatic thermoplastic welder according to the present invention, having a heat source that applies heat at the point of welding.

FIG. 9 is a schematic representation of the automatic thermoplastic welder according to the present invention, having a layer of conductive mesh.

### DETAILED DESCRIPTION OF THE PREFERRED EMBODIMENTS

The present invention is directed to a method for forming a thermoplastic composite, the method comprising: applying heat to a surface of a facing layer which is disposed opposite to the core; applying heat to at least one surface of the core layer which is disposed opposite the facing; and contacting the heated surface of the facing layer with the heated surface of the core layer under pressure, thereby forming the thermoplastic composite.

The pressure is preferably provided via at least one pair of oppositely disposed rollers, and wherein the facing layer and the core layer are continuously and simultaneously fed through the rollers. One versed in the art will understand that there are other methods of applying this continuous pressure and movement, such as belt or conveyor systems, or sequentially applied platens. Preferably, the heating steps and the contacting step are conducted substantially simultaneously. Also, it is preferable that the core layer be disposed between a first facing layer and a second facing layer.

The heat is typically applied to the facing layer and the core layer via at least one heating source either prior to or simultaneous with the contacting step. The heating source is selected from the group consisting of: electric heating elements, infrared heating elements, strip heaters, radiant heaters, ceramic fiber heaters, cartridge heaters, thick film nozzle heaters, thick film heaters on quartz, lasers, flame heaters, ultrasonic heaters and any combination thereof.

Optionally, heat can be applied by an electrically or magnetically conductive mesh that is disposed between the facing layer and the core layer. It is preferable that the facing layer, the conductive mesh, and the core layer are continuously and simultaneously fed to the contacting step.

In another embodiment a masking layer is disposed between the core layer and the heating source, the masking layer reducing degradation of the core layer during the heating of the core layer. Preferably, the masking layer, facing layer and core layer are continuously and simultaneously fed to the contacting step.

The present invention is also directed to a system for continuously forming a thermoplastic composite materials, the system comprising: a first feeder that continuously feeds a first facing layer; a second feeder that continuously feeds a core layer; a first heating source capable of heating a surface of the facing layer which is disposed opposite to the core layer and also heating a surface of the core layer which is disposed opposite the first facing layer; and at least one pair of pressure rollers that apply pressure to the heated facing layer and the core layer, thereby forming the thermoplastic composite material. Optionally, the system may include a third feeder that continuously feeds a second facing layer, and a second heating source. The second heating source is capable of heating a surface of the second facing layer, which is disposed opposite to the core layer, and also heating a surface of the core layer which is disposed opposite to the second facing layer.

The system may also optionally include a separate heating element, such that the first facing layer and the core layer each have their own independently controlled heating elements.

The system may also include a fourth feeder which continuously feeds a first electrically or magnetically conductive mesh that is disposed between the first facing layer and the core layer, and/or a fifth feeder which continuously feeds a second electrically or magnetically conductive mesh that is disposed between the second facing layer and the core layer.

The system may also optionally include a first masking layer disposed between the core layer and the first heating source, the masking layer reducing degradation of the core layer during the heating of the core layer, and/or a second masking layer disposed between the core layer and the second heating source, the masking layer reducing degradation of the core layer during the heating of the core layer. A sixth feeder is also provided which continuously feeds the first masking layer, and/or a seventh feeder is provided which continuously feeds the second masking layer.

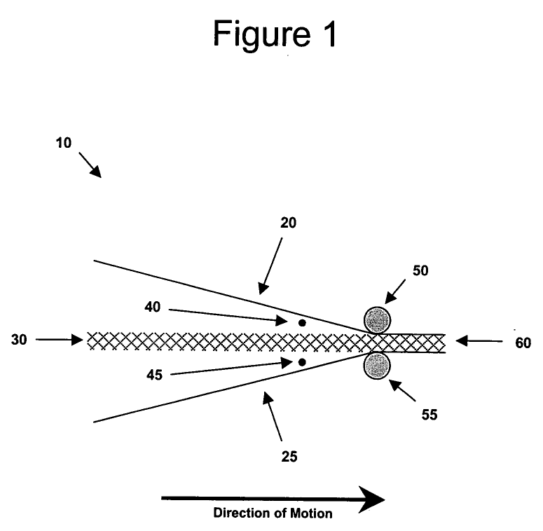

In the present invention, there are raw material inputs being fed automatically by roller or conveyor means into a welder. These raw materials include at least one thermoformable facing material and a thermoformable expandable core. Referring to FIG. 1, a first embodiment of the present invention is shown and generally referred to by reference numeral 10. The raw materials include a top facing material 20, a bottom facing material 25, and an expandable core 30. The present invention, however, contemplates a number of different combinations of facing material and expandable core. These combinations include, but are not limited to, one layer of facing material and one layer of expandable core, two layers of facing material and two layers of expandable core, such that the two layers of expandable core are bonded to each other, with the two layers of facing material bonded on the exterior faces of the expandable core layers, and three layers of facing material and two layers of expandable core, such that the two layers of expandable core have one layer of facing material disposed between them, and one layer each of facing material on the exterior face of the expandable cores. The present invention can also accommodate varying thicknesses of facing material and expandable core, and can adjust the speeds at which the materials are fed into welder 10.

Top and bottom facing materials 20 and 25, in sheet form, are preferably fed into the welder at opposing angles to allow space for top and bottom heat transfer elements 40 and 45. Heat transfer elements 40 and 45 transfer a sufficient amount of energy to top facing material 20, bottom facing material 25, and expandable core 30 so that they reach their respective melt and hot tack temperatures. Heat transfer elements 40 and 45 are linear electric heating elements or infrared heaters encased in glass; however, other types of energy sources are contemplated by the present invention, including, but not limited to, electric heating elements, infrared heating elements, strip heaters, radiant heaters, ceramic fiber heaters, cartridge heaters, thick film nozzle heaters, thick film heaters on quartz, lasers, flame heaters, ultrasonic heaters and any combination thereof. In addition, the present invention contemplates the use of an electrically or magnetically conductive mesh that is layered between the facing and expandable core materials, and heated at the point of contact with electricity or by electromagnetic induction to cause the facing and expandable core materials to bond together, discussed below. Additionally, the present invention includes a method for adjusting the amount of energy applied to the raw materials by heat transfer elements 40 and 45.

After passing through upper and lower heat transfer elements 40 and 45, the raw materials pass through upper and lower pressure rollers 50 and 55.

Rollers 50 and 55 apply pressure to the raw materials so that a bond is formed, and the resulting welded thermoplastic panel 60 is produced. The spacing of heat transfer elements 40 and 45, the angle that the elements are placed at, and the appropriate use of reflectors (not shown) is critical to deliver the right amount of energy so that the surfaces of top and bottom facing materials 20 and 25 and expandable core 30 can just reach their melt and hot tack temperatures. It is ideal to place heat transfer elements 40 and 45 as close to the bonding zone, defined by upper and lower pressure rollers 50 and 55, as possible. This spacing, however, will depend on the type of energy source used. For example, traditional infrared heating sources usually take up too much space to be located directly next to pressure rollers 50 and 55, and will need to be further away from the rollers than other energy sources, such as lasers or ultrasonic welders.

Support rollers (not shown) will be necessary to maintain the integrity of the different raw materials while they are being heated and conveyed to the weld bonding zone. The pressure applied by upper and lower pressure rollers 50 and 55, as well as the pressure applied by the support rollers, can be adjusted during the operation of welder 10.

Additional support rollers (not shown) are needed to hold the composite panel after the weld bonding zone as it cools and to prevent distortion while it is still hot. The rate of cooling and the time for cooling are subject to the specific materials and thicknesses used and the application for which the product will be used.

The automated welder of the present invention can accommodate a variety of different extruded thermoplastic materials such as high impact polystyrenes, polycarbonates, acrylonitrile butadiene styrenes, polypropylene-homo or co-polymers, low and high density polyethylenes, and any combinations thereof. These materials can be extruded or molded utilizing typical extruded materials, co-extruded materials, molded layers, alloys, fiber/filler/nano reinforced polymers, flexible polymeric materials, recycled materials or variations and combinations of all of the above.

One skilled in the art will be able also to weld, using the present invention, facing materials that are dissimilar to the expanded core material, as long as they are compatible for welding and as long as there melt temperatures are within a tolerance range of each other.

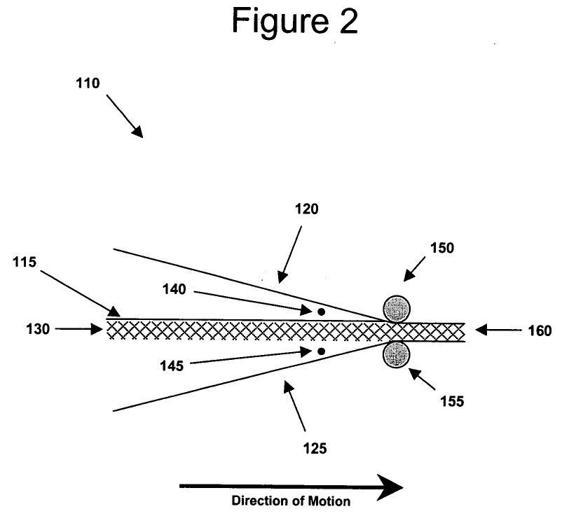

In another embodiment of the invention, shown in FIG. 2 and generally referred to by reference numeral 110, there is a mask with solid and open or translucent portions, such that the solid portions of the mask are in the shape and position of the openings of the cell holes in the expanded thermoformable material. Welder 110 has top facing material 120, bottom facing material 125, expandable core 130, upper and lower heat transfer elements 140 and 145, and upper and lower pressure rollers 150 and 155, which all function in a similar manner to the similarly numbered components of welder 10.

Welder 110 also has mask 115. In the shown embodiment, mask 115 is fed into welder 110 so that it is situated in between top facing material 120 and expanded core 130; however, in the present invention mask 115 can also be disposed in between bottom facing material 125 and expanded core 130. Welder 110 can also have a second mask layer such that there is one mask layer each between each of the facing materials 120 and 125 and expanded core 130. The solid portion of mask 115 reflects heat or thermal energy to prevent the interior cell walls of the expanded core 130 from overheating and collapsing under the bonding pressure applied by rollers 150 and 155. Mask 115 can also be made of a suitable material and thickness such that it becomes an integral part of the welded panel 160, having served its purpose of preventing excessive thermal energy from entering into the honeycomb cells and weakening them. Such a mask can be placed directly on expanded core 130 as it is fed into the device, and could be provided in sheet form or on a roll. One skilled in the art will understand that there are multiple ways of designing such a mask.

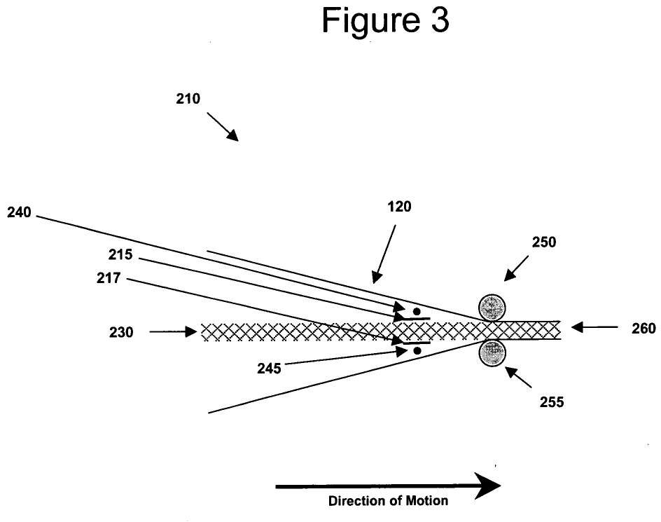

Referring to FIG. 3, another embodiment of the present invention is shown and generally referred to by numeral 210. Welder 210 has top facing material 220, bottom facing material 225, expanded core 230, upper and lower heat transfer elements 240 and 245, and upper and lower pressure rollers 250 and 255, which all function in a similar manner to the similarly numbered components of welder 10.

Welder 210 has upper and lower mask layer 215 and 217 respectively. In the shown embodiment, upper and lower mask layer 215 and 217 are disposed on either side of expanded core 230; however, the present invention contemplates the use of a single mask layer disposed on either side of expanded core 230. Upper and lower mask layers 215 and 217 are permanently affixed to welder 210 and situated such that they move in conjunction with expanded core 230 as it progresses under upper and lower heat transfer elements 240 and 245 toward upper and lower rollers 250 and 255, thus allowing the surface or surfaces of expanded core 230 to reach critical bonding temperatures while the interior remains at a lower, stable temperature. The movement of upper and lower mask layers 215 and 217 can optionally be controlled to shuttle back and forth, tracking the hole configuration of expanded core 230 as it moves forward towards the point of bonding, then quickly resetting and re-aligning at a point further back. The point at which upper and lower mask layers 215 and 217 begin their backwards reset would be located past the position of upper and lower heat transfer elements 240 and 245. At that point, expanded core 230 would no longer be absorbing further energy into the interior of the cells. One skilled in the art will understand that there are multiple ways of designing such a mask and moving it in tandem to control temperature differentials between the surface and interior of core material 230.

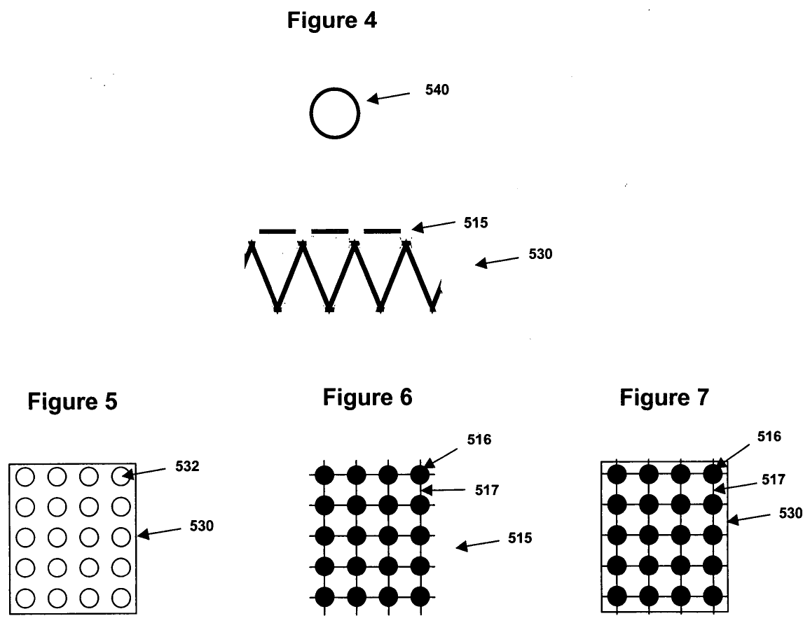

Referring to FIGS. 4 through 7, views of typical cross-sections of the expanded core materials and masks described in the above embodiments are shown. FIG. 4 shows a side view of an expanded core material 530. Expanded core 530 is typical of the expanded cores of the previous embodiments, for example expanded core 130 of welder 110. As shown in FIG. 5, which is a top view of expanded core 530, expanded core 530 can have a number of cells 532 that are formed during the expansion of the raw thermoplastic material into expanded core 530.

Mask layer 515, also shown in FIG. 4, is typical of the mask layers of previous embodiments, for example mask layer 115 of welder 110. As shown in FIG. 6, which is a top view of mask layer 515, mask layer 515 can also have a number of heat shields 516 and connectors 517. When mask layer 515 is superimposed over expanded core 530, as is shown in FIG. 7, heat shields 516 cover up cells 532. Thus, when mask layer 515 and expanded core 530 pass under a heat transfer element 540, as is shown in FIG. 4, heat shields 516 prevent the interior walls of cells 532 from absorbing too much heat and compromising the structural integrity of expanded core 530.

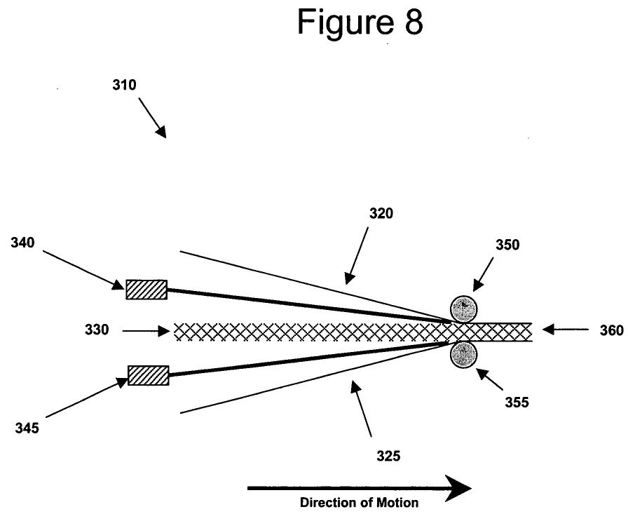

Referring to FIG. 8, a fourth embodiment of the present invention is shown and generally referred to by numeral 310. Welder 310 has top facing material 320, bottom facing material 325, expanded core 330, upper pressure roller 350, and lower pressure roller 355, which all function in a similar manner to the similarly numbered components of welder 10.

Welder 310 also has upper and lower laser heat sources 340 and 345. Upper and lower laser heat sources 340 and 345 are positioned to that they apply heat to top facing 320, bottom facing material 325, and the corresponding faces of expanded core 330 just at a point before the materials are passed through upper and lower pressure rollers 350 and 355. Thus, the surfaces of top facing material 320, bottom facing material 325, and expanded core 330 are raised to a temperature at which they will adhere to each other after passing through upper and lower pressure rollers 350 and 355, forming welded panel 360.

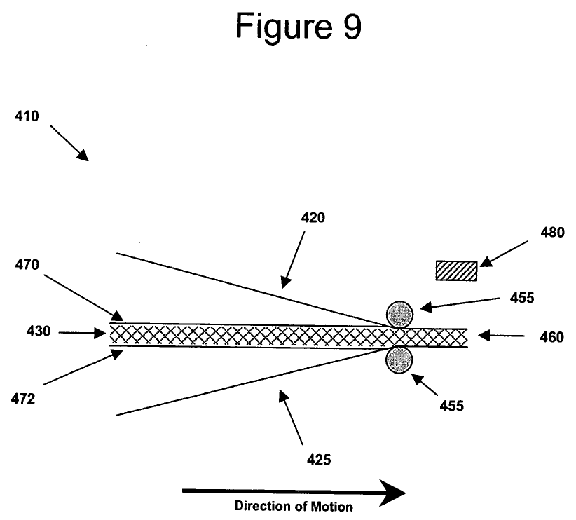

Referring to FIG. 9, a fifth embodiment of the present invention is shown and generally referred to by numeral 410. Welder 410 has upper facing material 420, bottom facing material 425, expanded core 430, upper pressure roller 450, and lower pressure roller 455, which all function in a similar manner to the similarly numbered components of welder 10.

Welder 410 also has upper conductive mesh 470 and lower conductive mesh 472, which are operably connected to power source 480. Upper and lower conductive mesh 470 and 472 are electrically or magnetically conductive, so that when connected to power source 480, they apply heat to the surface of expanded core 430, upper facing material 420, and bottom facing material 425, so that when the materials pass through upper and lower pressure rollers 450 and 455 they are welded into panel 460. Upper and lower conductive mesh 470 and 472 move with the expanded core 430 and upper and lower facing materials 420 and 425, and become bonded into the finished panel 460. The material of upper and lower conductive mesh 470 and 472 is made of a material that is sufficiently thin and open to allow the thermoformable materials of expanded core 430, upper facing material 420, and lower facing material 425 to weld bond between the threads, fibers or wires that comprise it. It will be understood by one versed in the art that there needs to be sufficient material in the mesh to create a generalized heated region when it conducts energy, yet open enough to allow weld bonding to take place.

The present invention also contemplates the use of a microprocessor that can receive inputs from a number of sensors located throughout any of the embodiments shown above, namely welders 10, 110, 210, 310, and 410. Such sensors can detect the surface temperature, thickness, color, reflectance, or absorption of the thermoformable materials used in the present invention, or any combination of these parameters. In addition, the microprocessor, optionally, receives inputs regarding characteristic of the raw materials used to form the welded panels, such as the bonding temperature of each raw material. The microprocessor processes this data using a unique algorithm to make continuous adjustments to welder 10 during operation, such as varying the distance between energy transfer elements 40 and 45 and pressure rollers 50 and 55, or by varying the amount of energy that the transfer elements apply to the raw materials being processed.

The present invention having been thus described with particular reference to the preferred forms thereof, it will be obvious that various changes and modifications may be made therein without departing from the spirit and scope of the present invention as defined herein.

What is claimed is:

1. A method for forming a thermoplastic composite, said method comprising:
applying heat to a surface of a facing layer which is disposed opposite to said core;
applying heat to at least one surface of said core layer which is disposed opposite said facing; and
contacting said heated surface of said facing layer with said heated surface of said core layer under pressure, thereby forming said thermoplastic composite.

2. The method of claim 1, wherein said pressure is provided via at least one pair of oppositely disposed rollers, and wherein said facing layer and said core layer are continuously and simultaneously feed through said rollers.

3. The method of claim 1, wherein said heating steps and said contacting step are conducted substantially simultaneously.

4. The method of claim 2, wherein said core layer in disposed between a first facing layer and a second facing layer.

5. The method of claim 1, wherein heat is applied to said facing layer and said core layer via at least one heating source either prior to or simultaneous with said contacting step.

6. The method of claim 5, wherein said heating source is selected from the group consisting of: electric heating elements, infrared heating elements, strip heaters, radiant heaters, ceramic fiber heaters, cartridge heaters, thick film nozzle heaters, thick film heaters on quartz, lasers, flame heaters, ultrasonic heaters and any combination thereof.

7. The method of claim 1, further comprising an electrically or magnetically conductive mesh disposed between said facing layer and said core layer.

8. The method of claim 7, wherein said facing layer, said conductive mesh, and said core layer are continuously and simultaneously fed to said contacting step.

9. The method of claim 7, wherein the conductive mesh is energized.

10. The method of claim 5, further comprising a masking layer disposed between said core layer and said heating source, said masking layer reducing degradation of said core layer during the heating of said core layer.

11. The method of claim 10, wherein said masking layer, facing layer and core layer are continuously and simultaneously fed to said contacting step.

12. A system for continuously forming a thermoplastic composite materials, said system comprising:
a first feeder that continuously feeds a first facing layer;
a second feeder that continuously feeds a core layer;
a first heating source capable of heating a surface of said facing layer which is disposed opposite to said core layer and also heating a surface of said core layer which is disposed opposite said first facing layer; and
at least one pair of pressure rollers that apply pressure to said heated 25 facing layer and said core layer, thereby forming said thermoplastic composite material.

13. The system of claim 12, wherein the heating source is moveable.

14. The system of claim 12, wherein the heating source can be masked on one side so that its output is variable from one side to the other.

15. The system of claim 12, wherein there are separate heating sources for the first layer and the core layer.

16. The system of claim 12, further comprising:
a third feeder that continuously feeds a second facing layer; and
a second heating source capable of heating a surface of said second facing layer which is disposed opposite to said core layer and also heating a surface of said core layer which is disposed opposite to said second facing layer.

17. The system of claim 12, wherein said heating source is at least one source selected from the group consisting of: electric heating elements, infrared heating elements, strip heaters, radiant heaters, ceramic fiber heaters, cartridge heaters, thick film nozzle heaters, lasers, flame heaters, ultrasonic heaters and thick film heaters on quartz.

18. The system of claim 12, further comprising:
a fourth feeder which continuously feeds a first electrically or magnetically conductive mesh that is disposed between said first facing layer and said core layer.

19. The system of claim 16, further comprising:
a fifth feeder which continuously feeds a second electrically or magnetically conductive mesh that is disposed between said second facing layer and said core layer.

20. The system of claim 12, further comprising a first masking layer disposed between said core layer and said first heating source, said masking layer reducing degradation of said core layer during the heating of said core layer.

21. The system of claim 16, further comprising a second masking layer disposed between said core layer and said second heating source, said masking layer reducing degradation of said core layer during the heating of said core layer.

22. The system of claim 20, further comprising:
a sixth feeder which continuously feeds said first masking layer.

23. The system of claim 21, further comprising:
a seventh feeder which continuously feeds said second masking layer.

24. The system of claim 12, further comprising:
a microprocessor; and
a temperature sensor that detects the temperature of said first facing layer after it passes through said first heating source;
wherein said microprocessor compares the temperature detected by said temperature sensor to a stored predetermined temperature and sends an output signal to said first heating source to increase or reduce energy so as to bring the temperature of said first facing layer to said predetermined temperature.

25. The method according to claim 1, further comprising:
detecting the temperature of said facing layer after said heating step;
comparing said detected temperature against a stored predetermined temperature; and
increasing or decreasing the heat being applied to said facing layer and/or said core layer depending upon whether the detected temperature is below or above said predetermined temperature.
